(19) United States
(12) Patent Application Publication
(10) Pub. No.: US 2019/0101169 A1
(43) Pub. Date: Apr. 4, 2019

(54) TORQUE LIMITER HAVING OVER-SPEED PROTECTION

(71) Applicant: Moog Inc., Elma, NY (US)

(72) Inventor: Lowell Van Lund LARSON, Huntington Beach, CA (US)

(21) Appl. No.: 15/719,871

(22) Filed: Sep. 29, 2017

(51) Int. Cl. F16D 7/02; F16D 43/21; F16D 43/22

(52) U.S. Cl. CPC F16D 7/027; F16D 43/22; F16D 43/216

(57) ABSTRACT

An apparatus for connecting a rotational drive member to a rotational driven member brakes rotation when either the torque transmitted between the members exceeds a predetermined torque limit or the rotational speed of the drive member exceeds a predetermined rotational speed limit. The apparatus includes a torque limiter configured to actuate a braking mechanism or disconnect transmission when the torque limit is exceeded, and an over-speed governor configured to trigger the torque limiter when the rotational speed of the input element exceeds the rotational speed limit. The over-speed governor may trigger the torque limiter by reducing the torque limit of the torque limiter, or by introducing rotational drag in the apparatus to increase transmitted torque.

### FIELD OF THE INVENTION

The present invention relates generally to torque limiters for preventing the transmission of torque from a driving element to a torque responsive element when a predetermined torque limit has been reached. More specifically, the present invention relates to a torque limiter configured to lockup when the driving element experiences a rotational over-speed condition.

### BACKGROUND OF THE INVENTION

Torque limiters are used in aircraft flight control systems to prevent the transmission of excess torque from a drive unit when a flight control surface actuated by the drive unit becomes jammed. Flight control surfaces include, for example, a trailing edge flap on a wing.

A torque limiter commonly includes an input element coupled to an output element through a braking mechanism responsive to an over-torque condition, as may be experienced when the output element is prevented from rotation due to a malfunction. In a well-known arrangement, the braking mechanism includes an axially displaceable braking element that transmits rotation from the input element to the output element during normal operation. The braking element is spring-biased in an axial direction toward the input element, and a plurality of angularly spaced balls are received in opposing recessed pockets in the input element and the braking element. When a torque limit is exceeded, the balls roll out of the pockets and axially displace the braking element against the spring bias into frictional engagement with grounded disc brakes to frictionally brake rotation of the input and output elements.

While torque limiters of the type described above are effective in preventing damage to mechanical drive components caused by over-torque, they do not provide any protection when an over-speed condition is experienced. In the context of aircraft control systems, an over-speed condition may occur if a torque tube that transmits torque to aircraft control surfaces undergoes failure and load is suddenly removed from the output element, thereby causing the input and output elements to rotate at a dangerously high number of revolutions per minute.

What is needed is a torque limiter that is capable of responding to an over-speed condition.

### SUMMARY OF THE INVENTION

The invention provides an apparatus for connecting a rotational drive member to a rotational driven member, wherein the apparatus brakes rotation when either the torque transmitted between the members exceeds a predetermined torque limit or the rotational speed of the drive member exceeds a predetermined rotational speed limit. The apparatus generally comprises a structural ground, a rotatable input element coupled to the drive member and a rotatable output element coupled to the driven member, a torque limiter configured to actuate a braking mechanism when the torque limit is exceeded to brake rotation, and an over-speed governor configured to trigger the torque limiter braking mechanism when the rotational speed of the input element exceeds the rotational speed limit.

In a first embodiment, the torque limiter includes a torque limit setting spring having a preload which defines the torque limit, and the over-speed governor acts to reduce the preload of the torque limit setting spring when the rotational speed limit is exceeded, thereby reducing the torque limit needed to trigger the torque limiter so that actuation of the torque limiter is caused by any applied torque. In the first embodiment, the over-speed governor may include a preload setting shaft engaging the torque limit setting spring, wherein the preload setting shaft is axially displaceable relative to a structural ground to set the preload of the torque limit setting spring. The over-speed governor of the first embodiment may also include at least one fly weight arranged on the input element for releasably holding the preload setting shaft in an axial setting position relative to the structural ground. The fly weight may directly engage the preload setting shaft in the manner of a sear, or it may radially confine a separate sear element for maintaining the preload setting shaft in its axial setting position. When the rotational speed of the input element exceeds the rotational speed limit, each fly weight moves radially outward by centrifugal force, thereby releasing the preload setting shaft to permit axial displacement of the preload setting shaft relative to the structural ground. The preload setting shaft is displaced by the torque limit setting spring relative to the structural ground, thereby reducing the preload. All or substantially all of the preload on the torque limit setting spring may be removed such that the over-speed governor reduces the torque limit to substantially zero torque and the torque limiter will be triggered by any transmitted torque.

The first embodiment may include means for resetting the torque limiter and over-speed governor for continued operation. The preload setting shaft may be urged back into its axial setting position against the bias of the torque limit setting spring by pressing an axially movable push button engaging an end of the preload setting shaft, inserting a puller tool into a tapped hole at an opposite end of the preload setting shaft and pulling the preload setting shaft, and/or introducing pressurized fluid into a cavity between the output element and the end of the preload setting shaft. The fly weights of the over-speed governor may be spring-biased to return to a radially inward position for holding the preload setting shaft upon its return to the axial setting position.

In a second embodiment, the over-speed governor is configured to add drag torque to the grounding brake of the torque limiter when the rotational speed limit is exceeded, thereby triggering the torque limiter to fully brake rotation. The over-speed governor of the second embodiment may include at least one fly weight arranged on a rotatable braking member of the torque limiter that is coupled to the input element. The at least one fly weight moves by centrifugal force when the rotational speed of the input element and coupled braking element exceed the rotational speed limit such that the fly weight applies axially directed force to disc brakes of the torque limiter to increase torque transmitted between the input and output elements. As a result, the torque limit is exceed and the torque limiter responds in the known manner to stop rotation. The over-speed governor of the second embodiment is resettable after an over-speed event by commanding reverse rotation of the drive member to impart reverse rotation to the input element.

The input element and output element are reversible in function, i.e. the input element may be used as an output element and the output element may be used as an input element.

### BRIEF DESCRIPTION OF THE DRAWING VIEWS

The nature and mode of operation of the present invention will now be more fully described in the following detailed description of the invention taken with the accompanying drawing figures, in which:

FIG. 1 is a cross-sectional view illustrating a torque limiter apparatus having over-speed protection in accordance with a first embodiment of the present invention, wherein the apparatus is shown in its normal operating condition;

FIG. 2 is a sectional view taken generally along the line 2-2 in FIG. 1;

FIG. 3 is a cross-sectional view similar to that of FIG. 1, wherein the apparatus is shown in an over-speed condition triggering an over-speed governor of the apparatus;

FIG. 4 is a sectional view taken generally along the line 4-4 in FIG. 3;

FIG. 5 is a cross-sectional view similar to that of FIG. 3, wherein the apparatus is shown having means for resetting the apparatus after the apparatus has been triggered by an over-speed condition;

FIG. 6 is an enlarged view of region A in FIG. 5 illustrating biasing of a fly weight of the over-speed governor;

FIG. 7 is a view similar to that of FIG. 6, wherein the apparatus has been reset;

FIG. 8 is a cross-sectional view similar to that of FIG. 5, wherein the apparatus is shown having alternative means for resetting the apparatus;

FIG. 9 is an enlarged view showing an alternative configuration of a fly weight in which the fly weight itself acts as a sear;

FIG. 10 is a cross-sectional view illustrating a torque limiter apparatus having over-speed protection in accordance with a second embodiment of the present invention, wherein the apparatus is shown in its normal operating condition;

FIG. 11 is a cross-sectional view similar to that of FIG. 5, wherein the apparatus is shown in an over-speed condition triggering an over-speed governor of the apparatus.

### DETAILED DESCRIPTION OF THE INVENTION

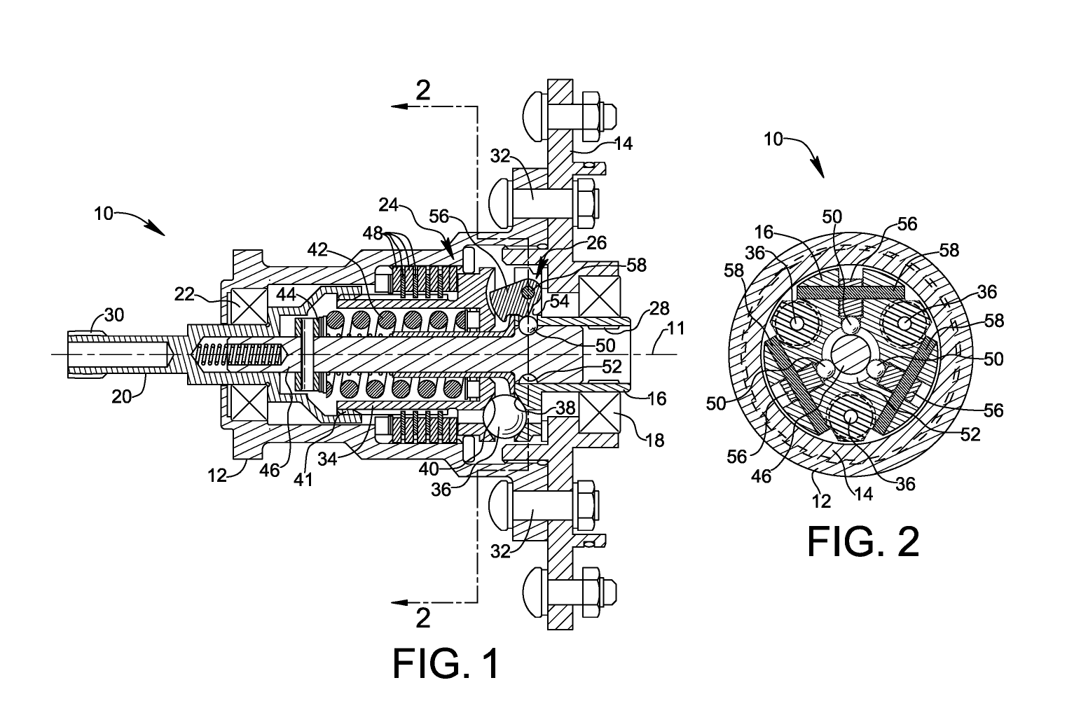

Reference is made initially to FIGS. 1-4, wherein a torque limiter apparatus formed in accordance with a first embodiment of the invention is shown and identified generally by reference numeral 10. Apparatus 10 comprises a structural ground in the form of housing members 12 and 14, an input element 16 rotatable about a rotational axis 11 relative to the structural ground by virtue of a rotary bearing 18, and an output element 20 rotatable relative to the structural ground by virtue of another rotary bearing 22. Apparatus 10 further comprises a torque limiter 24 and an over-speed governor 26 described in greater detail below. As will be understood, apparatus 10 is useful for connecting a rotational drive member (not shown) to a rotational driven member (not shown) by coupling the drive member to input element 16 and by coupling the driven member to output element 20. Coupling of the drive member to input element 16 may be achieved by a splined connection to a spline 28 of input element 16, and coupling of the driven member to output element 20 may be achieved by a splined connection to a spline 30 of output element 20. While splined couplings are shown, other types of couplings that provide transmission of rotational motion may be used. The connection provided by apparatus 10 provides both over-torque and over-speed protections in the transmission of rotational motion from the drive member to the driven member.

As mentioned above, housing members 12 and 14 act as a structural ground relative to which the input element 16 and the output element 20 rotate. Housing member 12 may be an axially elongated housing member surrounding the torque limiter 24 and the over-speed governor 26, and housing member 14 may be an end plate threadably coupled to housing member 12 and secured against rotation relative to housing member 12 by threaded fasteners 32. In the illustrated embodiment, rotary bearing 18 is nested in an annular recess of housing member 14 and rotatably supports input element 16, and rotary bearing 22 is nested in an annular recess of housing member 12 and rotatably supports output element 20.

Torque limiter 24 connects output element 20 to input element 16 for coupled rotation with the input element at the same rotational speed. Torque limiter 24 is actuated to brake rotation of input element 16 and output element 20 when torque transmitted between input element 16 and output element 20 exceeds a predetermined torque limit.

A torque limiter is a mechanical design element, used in the transmission system, to protect downstream components from excessive torque levels. A torque limiter either releases or locks to ground if the predetermined torque limit has been exceeded. There are three general types of torque limiters: sacrificial weak element, slip clutch, and torque brake.

The sacrificial weak element type is one that fractures and/or fully disconnects from the transmission drive line if the maximum design torque is exceeded. This type of torque limiter must be replaced or reset to transmit torque and return to operation after it is triggered. Examples of the sacrificial weak element type are shear and clear shafts, or ball or roller elements that snap over into a tripped condition and do not transmit any more torque.

The slip clutch type introduces slippage or losses into the system rig or the rotary relationship between the input and output shafts of the torque limiter if the torque limit has been exceeded. A slip clutch torque limiter may include spring-loaded brake plates or ball detents between input and output shafts. If the torque limit has been exceeded, the slip clutch torque limiter simply lets the output shaft slip at a different speed relative to the input shaft. Unlike the sacrificial weak element type, the slip clutch type transmits nearly the same maximum torque during a slip event and it automatically resets itself after the slip event.

The torque brake type maintains the system rig or the rotary relationship of the input and output shaft of the torque limiter, even if the torque limit has been exceeded. The torque brake type protects its output shaft from the excess torque at the input shaft by applying braking torque from the input shaft directly to the ground. The input torque is measured by a spring-loaded axial or radial ball ramp or cam, which applies force to brake plates or shoes, causing the brake plates or shoes to directly engage a grounded structure if the torque limit is exceeded. To reset or release the locked shaft, the input torque must be lowered to zero, and in some cases, the input shaft might need to back-up axially to release the brakes.

In the present disclosure, torque limiter 24 is embodied as a torque brake type torque limiter. However, torque limiter 24 may be embodied as another type of torque limiter, for example a sacrificial weak element type torque limiter or a slip clutch type torque limiter, without straying from the present invention.

In the illustrated embodiment, torque limiter 24 may include a braking member 34 arranged to transmit rotational motion from input element 16 to output element 20 during normal operation of apparatus 10 (i.e. when there is no over-torque or over-speed condition present). Braking member 34 may be coupled to input element 16 by a plurality of angularly spaced balls 36 received within opposing recessed pockets 38, 40 in input element 16 and braking member 34, respectively. Braking member 34 may be coupled to output element 20 by a splined connection 41 allowing braking member 34 to transmit rotational motion to output member 20 and to slide axially relative to output element 20. Thus, under normal operation, braking member 34 rotates with input element 16 and output element 20 at the same rotational speed. Torque limiter 24 may further include a torque limit setting spring 42 arranged to bias braking member 34 in an axial direction toward input element 16 to retain the balls 36 within corresponding opposing pockets 38, 40. In the illustrated embodiment, torque limit setting spring 42 has a first end operatively engaging an inner radial shelf of braking member 34 and a second end operatively engaging a flange 44 fixed at an axial location on a preload setting shaft 46. Torque limiter 24 may further include a plurality of disc brakes 48 arranged between braking member 34 and structural ground defined by an inner surface of housing member 12.

Under normal operating conditions, the preload setting shaft 46 may be held at a predetermined axial setting position relative to input element 16 and structural ground members 12, 14 by one or more sears 50 partially received by a corresponding sear groove 52 in preload setting shaft 46 and partially received by a respective radially extending recess 54 in input element 16. As shown in FIG. 2, sear groove 52 may be part of a continuous circumferential groove about preload setting shaft 46. Alternatively, sear groove 52 may be a local notch or indentation arranged to receive a respective sear 50. The axial setting position of preload setting shaft 46 determines the preload applied to torque limit setting spring 42, which in turn determines the torque limit above which torque limiter 24 is triggered. When the torque limit is exceeded, balls 36 will roll out of pockets 38, 40 and displace braking member 34 in an axial direction relative to structural ground 12, 14 against the force of spring 42. As a result, braking member 34 is pushed axially into engagement with disc brakes 48, thereby increasing friction and causing the rotating input and output elements 16 and 20 to lock-up and stop rotating. When the preload on torque limit setting spring 42 is relatively low, balls 36 are not held as tightly within pockets 38, 40 and the balls will roll out of pockets 38, 40 at a lower torque threshold to actuate braking. Conversely, when the preload on torque limit setting spring 42 is relatively high, balls 36 are held more tightly within pockets 38, 40 and a higher torque threshold must be exceeded before balls 36 are caused to roll out of pockets 38, 40 to actuate braking.

Over-speed governor 26 is configured to cause actuation of torque limiter 24 to brake rotation of input element 16 and output element 20 when rotational speed of input element 16 exceeds a rotational speed limit. In the first embodiment depicted in FIGS. 1-4, over-speed governor 26 causes actuation of torque limiter 24 by reducing the preload of torque limit setting spring 42 when the rotational speed limit is exceeded, thereby reducing the torque limit. In the configuration of over-speed governor 26 shown in FIGS. 1-4 and described below, over-speed governor 26 reduces the torque limit to substantially zero torque by removing all or substantially all preload from torque limit setting spring 42. Consequently, as a result of an over-speed event, any torque will trigger torque limiter 24.

Over-speed governor 26 may include preload setting shaft 46, one or more sears 50, and at least one fly weight 56. As described above, preload setting shaft 46 engages an end of the torque limit setting spring 42, is axially displaceable relative to structural ground 12, 14 to set the preload of torque limit setting spring 42, and has one or more sear grooves 52. Each sear 50 may be a ball partially received by a corresponding sear groove 52 and partially received by a corresponding radially extending recess 54 in input element 16 to maintain an axial setting position of preload setting shaft 46 relative to structural ground 12, 14 during normal operation when the rotational speed of input element 16 does not exceed the rotational speed limit. The normal operating condition is shown in FIGS. 1-2. Each fly weight 56 may be arranged on input element 16 to retain a respective sear 50 partially in sear groove 52 of preload setting shaft 46 when the rotational speed of input element 16 does not exceed the rotational speed limit.

In the depicted embodiment, each fly weight 56 is pivotally mounted to input element 16 by a pivot pin or pivot axle 58. As shown in FIG. 2, a plurality of fly weights 56 may be angularly spaced about rotational axis 11 of input element 16, and a plurality of sears 50 may be respectively received within a plurality of radially extending recesses 54 angularly spaced about rotational axis 11 of input element 16. The illustrated embodiment provides three sears 50 and three fly weights 56 spaced at regular angular intervals of 120° about rotational axis 11 for balanced operation. It will be understood that more or fewer sears 50 and fly weights 56 may be used.

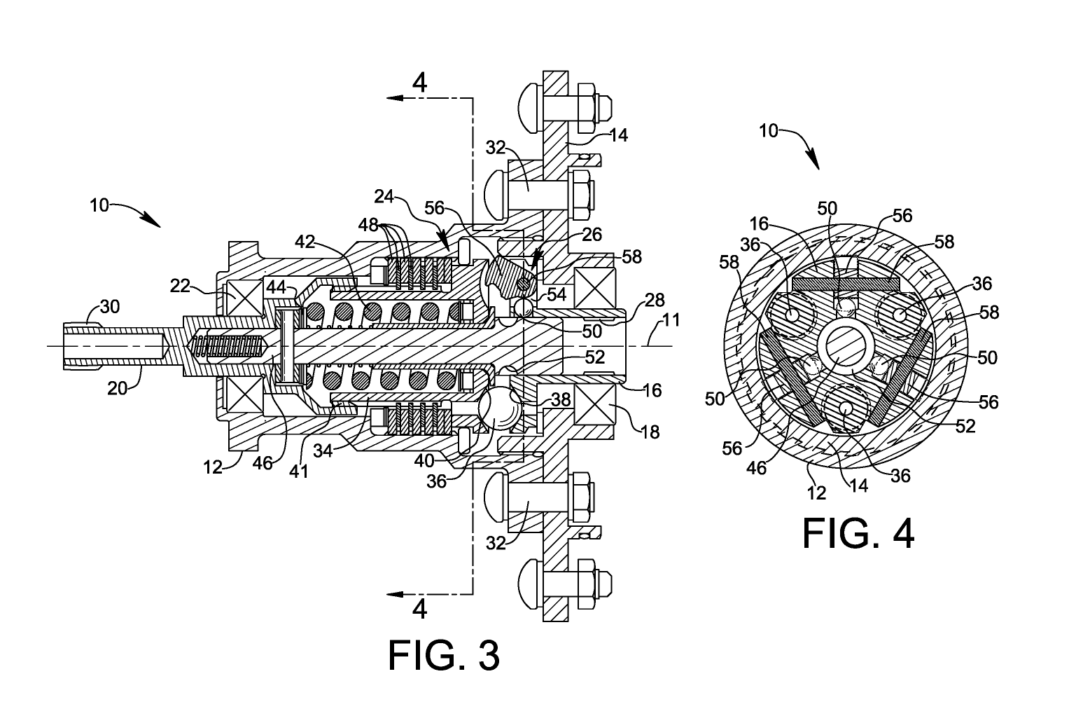

Referring specifically now to FIGS. 3 and 4, operation of apparatus 10 during an over-speed event is shown. When the rotational speed of the input element 16 exceeds the rotational speed limit, centrifugal force causes each fly weight 56 to pivot about its associated pivot pin 58 in a direction away from the corresponding sear 50 (e.g. clockwise in FIG. 3), and centrifugal force causes each sear 50 to move radially outward such that the sear 50 withdraws completely from sear groove 52 to permit axial displacement of preload setting shaft 46 relative to structural ground 12, 14. As a result, preload setting shaft 46 is displaced by torque limit setting spring 42 relative to structural ground 12, 14, thereby reducing the preload applied to torque limit setting spring 42. As best seen in FIG. 3, the permitted displacement of preload setting shaft 46 may be sufficient to remove all or substantially all preload in torque limit setting spring 42 so as to reduce the torque limit to essentially zero torque. Consequently, torque limiter 24 is actuated as described above to brake rotation of input element 16 and output element 20.

As may be understood, the rotational speed limit above which over-speed governor 26 is triggered may be determined by designing the mass and center of gravity of the at least one fly weight 56 such that a predetermined rotational speed of input element 16 is required before pivoting of the at least one fly weight occurs. Additionally, each fly weight 56 may be spring-loaded toward a non-triggered position, wherein the preload must be overcome by centrifugal force. Over-speed governor 26 may be balanced and calibrated as known in the art such that all sears 50 are released and travel radially outward simultaneously. Once over-speed governor 26 is triggered and the preload on torque limit setting spring 42 is discharged, apparatus 10 will remain stopped and resetting the apparatus is not possible without disassembly.

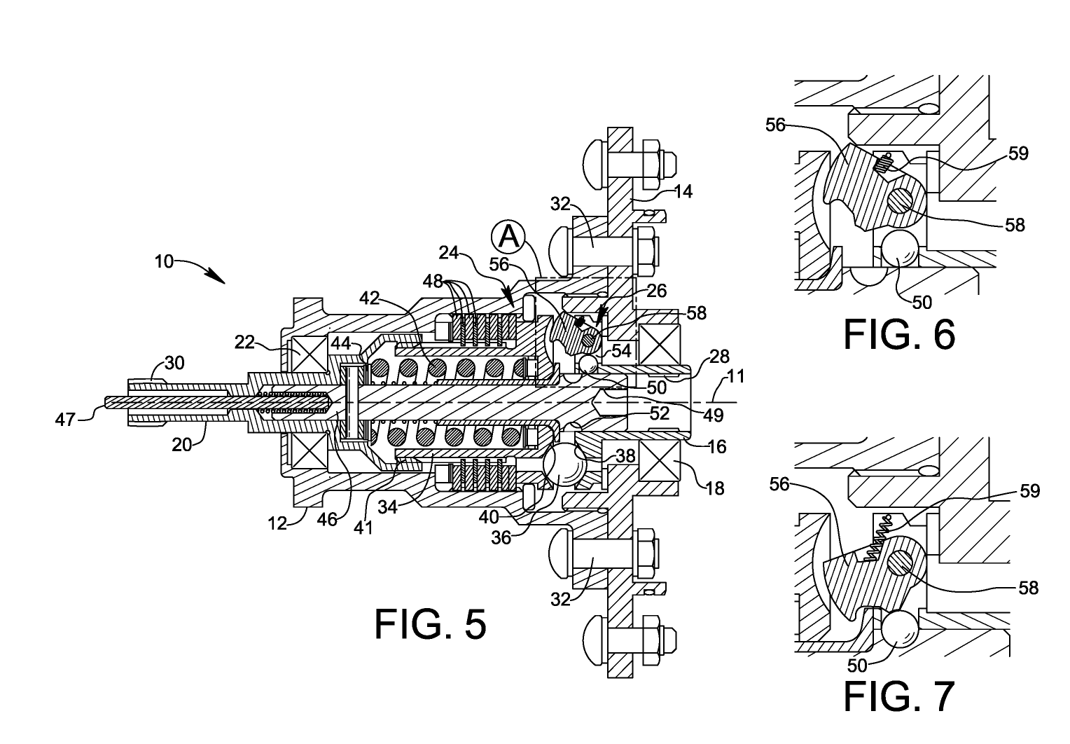

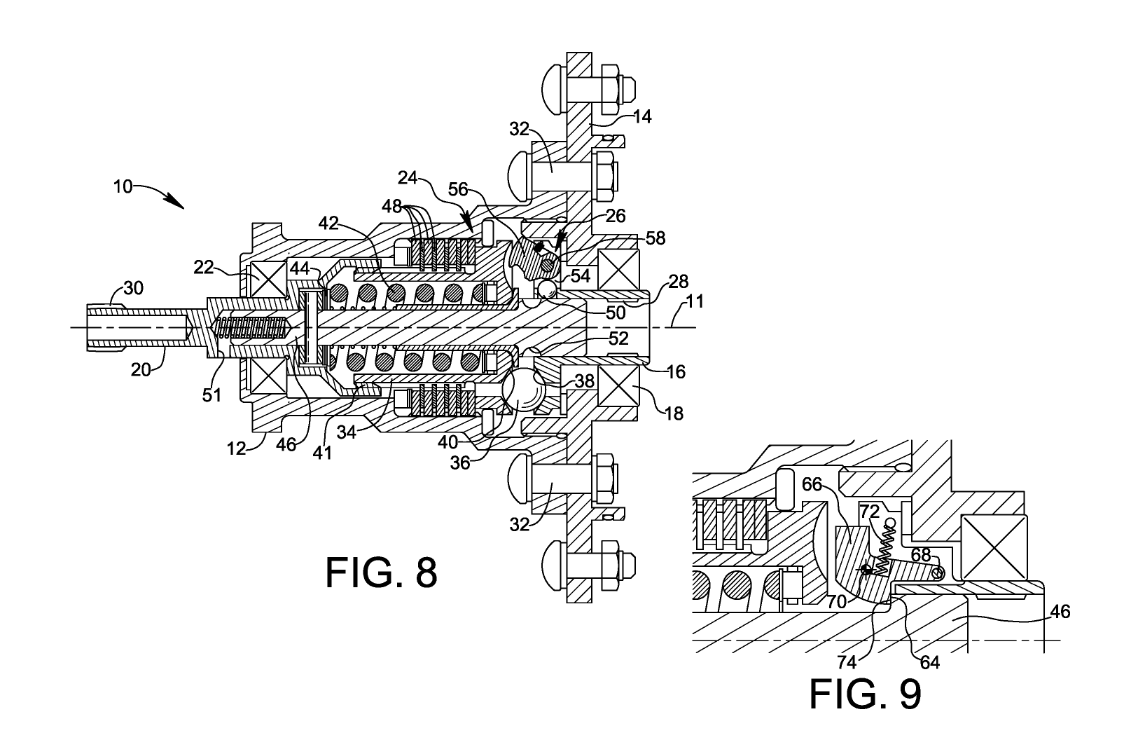

FIGS. 5-8 illustrate modifications to the apparatus 10 enabling the apparatus to be reset after an over-speed event. In the variant shown in FIG. 5, apparatus 10 is adapted to allow a user to axially push or pull preload setting shaft 46 back into its original preload setting position without disassembly. A push button 47 may be axially slidable through a passage in output element 20 to exert force on an end of preload setting shaft 46 to push the preload setting shaft back into the predetermined preload setting position against the bias of torque limit setting spring 42. In addition to push button 47, or as an alternative to the push button, an opposite end of preload setting shaft 46 may be adapted to releasably mate with a puller tool (not shown) so that a user may pull preload setting shaft 46 back into the predetermined preload setting position against the bias of torque limit setting spring 42. For example, a tapped hole 49 may be provided at the opposite end of preload setting shaft 46 to mate with a threaded tip of a puller tool inserted through a passage in input element 16. As shown in FIGS. 6 and 7, each fly weight 56 may be biased by a spring 59 toward a non-triggered position, whereby the fly weight will return to a position for holding preload setting shaft 46 in the axial setting position as preload setting shaft 46 reaches the axial setting position during reset. FIG. 8 shows another modification wherein the output element 20 is provided with a nipple or sealable port 51 through which pressurized fluid, for example grease from a grease gun, may be injected into a cavity between output element 20 and the end of preload setting shaft 46 to force preload setting shaft 46 back into its axial setting position.

FIG. 9 illustrates a fly weight 66 according to an alternative design which avoids the use of a separate sear element such as balls 50. Similar to fly weight 56 described above, fly weight 66 is pivotally mounted to input element 16 by a pivot pin or pivot axle 68. Fly weight 66 directly engages preload setting shaft 46 in the manner of a sear for maintaining the preload setting shaft in its axial setting position, and moves out of engagement to release preload setting shaft 46 when the rotational speed limit is exceeded. In the illustrated design, fly weight 66 includes a latching edge 64 arranged to engage a radial shoulder 74 of preload setting shaft 46. When the rotational speed limit is exceeded, the center of gravity 70 of fly weight 66 is forced radially outward, causing fly weight 66 to pivot clockwise in the view of FIG. 9 against the bias of resetting spring 72 to disengage latching edge 64 from radial shoulder 74 and release preload setting shaft 46. When this happens, preload on torque limit setting spring 42 forces preload setting shaft 46 to the left in FIG. 9 thereby discharging the preload so that torque limiter 24 is triggered by any torque transmission.

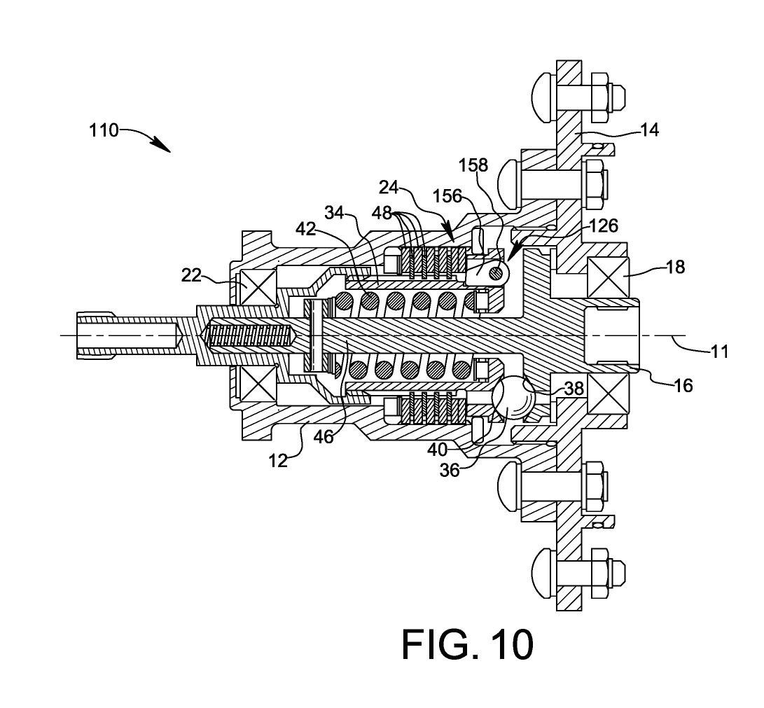

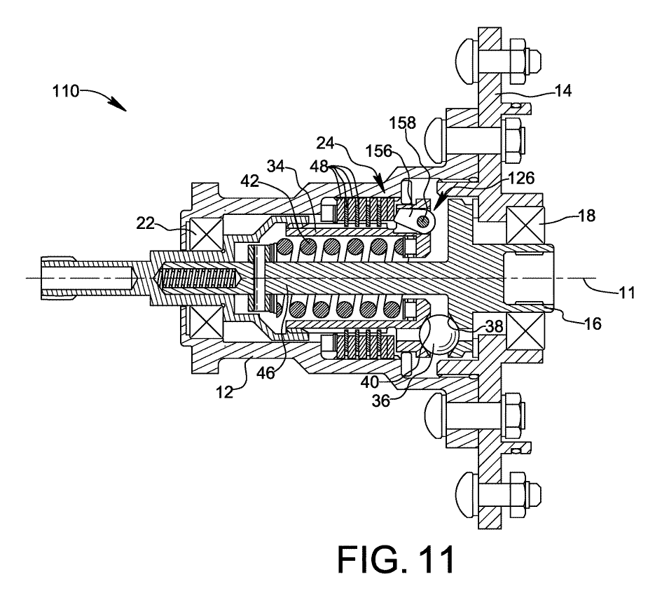

FIGS. 10 and 11 illustrate a torque limiter apparatus 110 having over-speed protection in accordance with a second embodiment of the present invention. The second embodiment differs from the first embodiment described above in that the over-speed governor of the second embodiment acts to add drag torque to the grounding brake of the torque limiter when the rotational speed limit is exceeded, thereby triggering the torque limiter.

FIG. 10 shows apparatus 110 during a normal operating condition, whereas FIG. 11 shows apparatus 110 in an over-speed condition triggering an over-speed governor 126 of the apparatus. In contrast to over-speed governor 26 of the first embodiment, over-speed governor 126 of the second embodiment does not change the preset torque limit of torque limiter 24 when the rotational speed limit is exceeded, but merely adds drag to the system to trigger torque limiter 24. By operating in this manner, over-speed governor 126 of the second embodiment allows torque limiter 24 to be reset by commanding reverse rotation of the drive member to rotate input element 16 in an opposite rotational direction, and disassembly or manual intervention is not required to reset apparatus 110.

Apparatus 110 of the second embodiment is similar to apparatus 10 of the first embodiment in that it comprises torque limiter 24, described above. Torque limiter 24 may include rotatable braking member 34 arranged to transmit rotational motion from the input member 16 to output member 20, and disc brakes 48 arranged between braking member 34 and structural ground 12, 14. As in the first embodiment, braking member 34 is axially displaced relative to structural ground 12, 14 to engage disc brakes 48 when the torque limit is exceeded. Preload setting shaft 46 may be integrally formed with input element 16.

Over-speed governor 126 includes at least one fly weight 156 arranged on braking member 34. Each fly weight 156 may be pivotally mounted to braking member 34 by a pivot pin or pivot axle 158. Similar to the first embodiment, a plurality of fly weights 156 may be angularly spaced about rotational axis 11 of input element 16, which corresponds to the rotational axis of braking member 34. For example, three fly weights 156 may be spaced at regular angular intervals of 120° about rotational axis 11 for balanced operation. It will be understood that more or fewer fly weights 156 may be used.

As shown in FIG. 11, when input element 16 exceeds the rotational speed limit, each fly weight 156 moves by centrifugal force such that it applies axially directed force to disc brakes 48. As illustrated in FIG. 11, movement of each fly weight 156 may be pivotal movement about corresponding pivot pin or pivot axle 158. The application of force to disc brakes 48 by each fly weight 156 increases frictional resistance to rotation, thereby increasing torque transmitted between input element 16 and output element 20. As a result, the predetermined torque limit is exceeded in an over-speed condition causing actuation of torque limiter 24. Following actuation, torque limiter 24 may be reset by commanding reverse rotation of the drive element to rotate input element 16 in an opposite rotational direction, thereby causing balls 36 to roll back into pockets 38, 40.

With respect to the embodiments described above, those skilled in the art will realize that input element 16 and output element 20 are reversible in function, i.e. input element 16 may be used as an output element coupled to an external driven member, and output element 20 may be used as an input element to which an external drive member is coupled. In such an arrangement, element 20 is considered an “input element” and element 16 is considered an “output element.”

The invention improves safety by providing an over-speed governor configured to cooperate with a torque limiter apparatus. The invention utilizes the existing capability of the torque limiter during an over-speed event, thereby avoiding additional braking or torque limiting components and external controls.

While the invention has been described in connection with exemplary embodiments, the detailed description is not intended to limit the scope of the invention to the particular forms set forth. The invention is intended to cover such alternatives, modifications and equivalents of the described embodiment as may be included within the scope of the claims.

What is claimed is:

1. An apparatus for connecting a rotational drive member to a rotational driven member, the apparatus comprising:
a structural ground;
an input element rotatable relative to the structural ground;
an output element rotatable relative to the structural ground;
a torque limiter connecting the output element to the input element for rotation with the input element, wherein the torque limiter is actuated to brake rotation of the input element and the output element, or to disconnect the input element from the output element, when torque transmitted between the input element and the output element exceeds a torque limit; and
an over-speed governor configured to cause actuation of the torque limiter to brake rotation of the input element and the output element, or to disconnect the input element from the output element, when rotational speed of the input element exceeds a rotational speed limit.

2. The apparatus according to claim 1, wherein the torque limiter includes a torque limit setting spring having a preload defining the torque limit, and the over-speed governor causes actuation of the torque limiter by reducing the preload of the torque limit setting spring when the rotational speed limit is exceeded, thereby reducing the torque limit.

3. The apparatus according to claim 2, wherein the over-speed governor reduces the torque limit to substantially zero torque when the rotational speed limit is exceeded.

4. The apparatus according to claim 2, wherein the over-speed governor includes:
a preload setting shaft engaging the torque limit setting spring, the preload setting shaft being axially displaceable relative to the structural ground to set the preload of the torque limit setting spring;
at least one fly weight arranged on the input element to hold the preload setting shaft at an axial setting position when the rotational speed of the input element does not exceed the rotational speed limit;
wherein the at least one fly weight moves by centrifugal force when the rotational speed of the input element exceeds the rotational speed limit to release the preload setting shaft and permit axial displacement of the preload setting shaft away from the axial setting position thereby reducing the preload of the torque limit setting spring.

5. The apparatus according to claim 4, wherein the at least one fly weight is pivotally mounted to the input element.

6. The apparatus according to claim 4, wherein the at least one fly weight directly engages the preload setting shaft to hold the preload setting shaft at the axial setting position when the rotational speed of the input element does not exceed the rotational speed limit.

7. The apparatus according to claim 4, wherein the at least one fly weight directly indirectly engages the preload setting shaft through a sear to hold the preload setting shaft at the axial setting position when the rotational speed of the input element does not exceed the rotational speed limit.

8. The apparatus according to claim 7, wherein the preload setting shaft includes a sear groove therein and the input element includes a radially extending recess, and wherein the sear is partially received by the sear groove and partially received by a radially extending recess to hold the preload setting shaft at the axial setting position when the rotational speed of the input element does not exceed the rotational speed limit.

9. The apparatus according to claim 4, wherein the at least one fly weight comprises a plurality of fly weights angularly spaced about a rotational axis of the input element.

10. The apparatus according to claim 4, further comprising a button arranged to push the preload setting shaft into the axial setting position to reset the apparatus after an over-speed event.

11. The apparatus according to claim 4, wherein the preload setting shaft is adapted for mating with a tool for moving the preload setting shaft into the axial setting position to reset the apparatus after an over-speed event.

12. The apparatus according to claim 11, wherein the preload setting shaft includes a tapped hole for mating with a threaded tool.

13. The apparatus according to claim 4, wherein the output element includes a fluid injection port through which pressurized fluid is injectable into a cavity to force the preload setting shaft into the axial setting position to reset the apparatus after an over-speed event.

14. The apparatus according to claim 1, wherein the over-speed governor causes actuation of the torque limiter by increasing torque transmitted between the input element and the output element when the rotational speed limit is exceeded.

15. The apparatus according to claim 14, wherein:
the torque limiter includes a rotatable braking member arranged to transmit rotational motion from the input member to the output member and a plurality of disc brakes arranged between the braking member and the structural ground, the braking member being axially displaced relative to the structural ground to engage the plurality of disc brakes when the torque limit is exceeded; and
the over-speed governor includes at least one fly weight arranged on the braking member, wherein the at least one fly weight moves by centrifugal force when the rotational speed of the input element exceeds the rotational speed limit such that the at least one fly weight applies axially directed force to the plurality of disc brakes to increase torque transmitted between the input element and the output element.

16. The apparatus according to claim 15, wherein the at least one fly weight is pivotally mounted to the braking member.

17. The apparatus according to claim 15, wherein the at least one fly weight comprises a plurality of fly weights angularly spaced about a rotational axis of the braking member.

18. The apparatus according to claim 14, wherein the apparatus is resettable after an over-speed event by commanding reverse rotation of the rotational drive member to impart reverse rotation to the input element.
